(19) United States
(12) Patent Application Publication
(10) Pub. No.: US 2014/0138311 A1
(43) Pub. Date: May 22, 2014

(54) APPARATUS AND METHOD FOR REDUCING NITRATE USING IRON-OXIDIZING MICROORGANISM

(71) Applicant: KOREA INSTITUTE OF SCIENCE AND TECHNOLOGY, Seoul (KR)

(72) Inventors: Yong Su CHOI, Seoul (KR); Jae Shik CHUNG, Seoul (KR); Hyokwan BAE, Ulsan (KR); Hwa Yeon JEON, Hwayang-myeon (KR); Seockheon LEE, Seoul (KR)

(21) Appl. No.: 13/928,051

(22) Filed: Jun. 26, 2013

(30) Foreign Application Priority Data
Nov. 20, 2012 (KR) 10-2012-0131612

(51) Int. Cl. C02F 3/34

(52) U.S. Cl. CPC C02F 3/346
USPC 210/631; 210/198.1

(57) ABSTRACT

Disclosed herein are an apparatus and method for reducing nitrate using iron-oxidizing microorganisms, which can easily reduce nitrate using iron-oxidizing microorganisms. The apparatus includes: a nitrate-reducing reactor which is operated under anaerobic conditions and provides a space for reduction of nitrate; and an iron-oxidizing microorganism provided in the nitrate-reducing reactor, wherein the iron-oxidizing microorganism releases divalent iron (Fe²⁺), the released Fe²⁺ is converted to Fe³⁺ by microbial oxidation under anaerobic conditions while releasing an electron, and the released electron is used in the reduction of nitrate into nitrogen gas by the iron-oxidizing microorganism.

### CROSS-REFERENCE TO RELATED APPLICATION

This application claims priority to Korean Patent Application No. 10-2012-131612, filed on Nov. 20, 2012, and all the benefits accruing therefrom under 35 U.S.C. §119, the contents of which in its entirety are herein incorporated by reference.

### BACKGROUND

1. Field

The present disclosure relates to an apparatus and method for reducing nitrate using an iron-oxidizing microorganism, and more particularly to an apparatus and method for reducing nitrate using an iron-oxidizing microorganism, which can easily reduce nitrate using the iron-oxidizing microorganism.

2. Description of the Related Art

In general, advanced biological treatment processes are used to adulterations, organic matter, nitrogen and phosphorus in sewage and wastewater. Particularly, nitrogen in sewage and wastewater is treated in a nitrification reactor and a denitrification reactor. Specifically, ammonia nitrogen is nitrified, and then reduced into nitrogen gas. Such biological nitrification/denitrification processes are advantageously applied for the treatment of sewage and wastewater containing high concentrations of organic matter and ammonia nitrogen, such as leachate water or livestock water.

Conventional methods for removing nitrogen using sewage/wastewater treatment systems are as follows. A method which is most frequently used to remove nitrogen from sewage and wastewater is a biological nitrogen removal method in which ammonia nitrogen is converted into nitrite nitrogen or nitrate using autotrophic microorganisms, and then denitrified by heterotrophic microorganisms.

Heterotrophic denitrification is highly efficient in terms of the removal of nitrate when a suitable amount of organic matter is used, but has a problem in that, when the content of organic matter in sewage is insufficient compared to the content of nitrogen, expensive chemicals such as ethanol are required to be additionally supplied.

In attempts to solve this problem, various methods for removing nitrate have been proposed. Specifically, Korean Patent Registration No. 1164214 discloses technology for reducing and removing nitrate using a combination of a clay mineral and zero-valent iron. Korean Patent Registration No. 1177757 discloses technology for removing nitrate from raw water using hydrogen gas. However, the technologies disclosed in the above patent documents have a problem in that these are difficult to apply to biological sewage/wastewater treatment processes or require a separate unit for the supply of hydrogen gas.

### SUMMARY

Accordingly, the present disclosure has been made in order to solve the above-described problems, and it is an object of the present disclosure to provide an apparatus and method for reducing nitrate using an iron-oxidizing microorganism, which can easily reduce nitrate using an iron-oxidizing microorganism.

Another object of the present disclosure is to provide a method for preparing a carrier capable of loading an iron-oxidizing microorganism.

To achieve the above objects, the present disclosure provides an apparatus for reducing nitrate using an iron-oxidizing microorganism, the apparatus including: a nitrate-reducing reactor which is operated under anaerobic conditions and provides a space for reduction of nitrate; and an iron-oxidizing microorganism provided in the nitrate-reducing reactor, wherein the iron-oxidizing microorganism releases divalent iron (Fe²⁺), the released Fe²⁺ is converted to Fe³⁺ by microbial oxidation under anaerobic conditions while releasing an electron, and the released electron is used in the reduction of nitrate into nitrogen gas by the iron-oxidizing microorganism. Sodium carbonate (Na₂CO₃) and ferrous ion (Fe²⁺) or iron (Fe) compounds are supplied to the nitrate-reducing reactor. The iron-oxidizing microorganism takes an iron compound formed by a reaction between sodium carbonate (Na₂CO₃) and iron (Fe) compounds while releasing divalent iron (Fe²⁺) and reduces nitrate into nitrogen gas using an electron generated by microbial oxidation of Fe²⁺.

The nitrate-reducing reactor further includes an iron supply unit, and the iron supply unit serves to supply the iron compound. The iron-oxidizing microorganism is provided in a state in which it is loaded into a carrier.

The carrier having the iron-oxidizing microorganism loaded therein may be prepared by a carrier preparation process comprising: preparing a mixed solution of PVA (polyvinyl alcohol), sodium alginate and distilled water; mixing a sludge containing an iron-oxidizing microorganism with the mixed solution at a volume ratio of 1:1 to prepare a sludge solution; and gelling the sludge solution.

The nitrate-reducing reactor serves to treat raw water discharged from a biological sewage/wastewater treatment apparatus or an artificial wetland, and the raw water contains nitrate.

A method for reducing nitrate using an iron-oxidizing microorganism according to the present disclosure includes providing a carrier containing the iron-oxidizing microorganism in a nitrate-reducing reactor, which is operated under anaerobic conditions, and in this state, supplying sodium carbonate (Na₂CO₃) and ferrous ion (Fe²⁺) or iron (Fe) compounds to the nitrate-reducing reactor, wherein the iron-oxidizing microorganism releases divalent iron (Fe²⁺), the released Fe²⁺ is converted to Fe³⁺ by microbial oxidation under anaerobic conditions while releasing an electron, and the released electron is used in the reduction of nitrate into nitrogen gas by the iron-oxidizing microorganism.

The apparatus and method for reducing nitrate using the iron-oxidizing microorganism according to the present disclosure have the following effects.

In the reduction of nitrate, the supply of separate organic matter is not required, and an alkaline material, which is present in sewage or wastewater, and iron which can be easily obtained in nature, are used as materials for denitrification. Thus, the operating cost can be reduced. In addition, because the iron-oxidizing microorganism is loaded into a carrier, it can be recycled, and construction wastes such as a slag can be used as iron required for the growth of the iron-oxidizing microorganism. Thus, the operating cost can be minimized.

### BRIEF DESCRIPTION OF THE DRAWINGS

FIG. 1 shows the configuration of an apparatus for reducing nitrate using an iron-oxidizing microorganism according an embodiment of the present disclosure.

FIG. 2 is a photograph showing an actually constructed apparatus for reducing nitrate using an iron-oxidizing microorganism according an embodiment of the present disclosure.

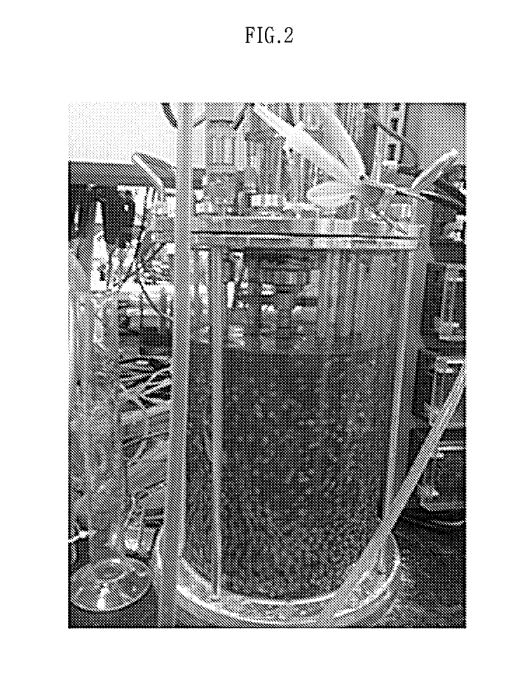

### DETAILED DESCRIPTION

The present disclosure proposes technology for reducing nitrate in water into nitrogen by an iron-oxidizing microorganism, which uses iron as an electron donor and releases iron by metabolic processes.

The iron-oxidizing microorganism releases divalent iron (Fe²⁺), the released Fe²⁺ is converted to Fe³⁺ by microbial oxidation under anaerobic conditions while releasing an electron, and the released electron is used in the reduction of nitrate (NO₃—N) into nitrogen gas by the iron-oxidizing microorganism.

The iron-oxidizing microorganism may be provided in a nitrate-reducing reactor, which is in an anaerobic state or an oxygen-free state, and the iron-oxidizing microorganism may be present in a form in which it is predominantly cultured in raw water in nitrate-reducing reactor. In addition, in order to prevent the iron-oxidizing microorganism from being lost and recycle the iron-oxidizing microorganism, the iron-oxidizing microorganism may be loaded into a carrier.

Hereinafter, an apparatus and method for reducing nitrate using an iron-oxidizing microorganism according to an embodiment of the present disclosure will be described in detail with reference to the accompanying drawings.

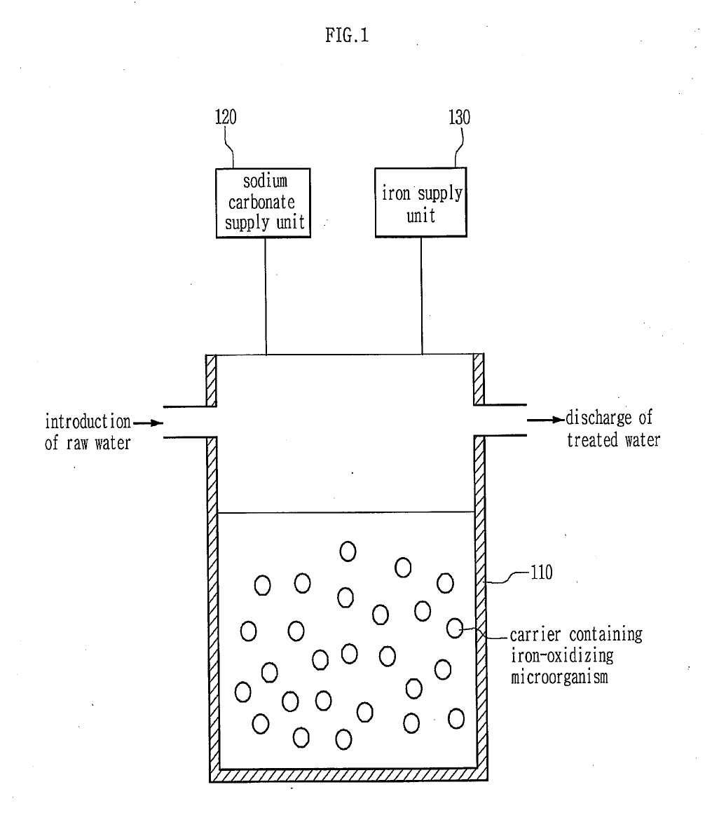

Referring to FIG. 1, an apparatus for reducing nitrate using an iron-oxidizing microorganism according to an embodiment of the present disclosure comprises a nitrate-reducing reactor 110. The nitrate-reducing reactor 110 is operated under anaerobic or oxygen-free conditions, and raw water containing the nitrate or nitrate to be denitrified is continuously introduced into the nitrate-reducing reactor 110. The nitrate-reducing reactor 110 may be connected with a biological sewage/wastewater treatment apparatus. In an embodiment, the nitrate-reducing reactor 110 may be substituted for the oxygen-free tank or anaerobic tank of the biological sewage/wastewater treatment apparatus or may serve as a separate reactor that receives a sludge returned from an aeration tank. In other words, the nitrate-reducing reactor 110 may serve to receive a sludge returned from an aeration tank and reduce nitrate in the sludge. Alternatively, it may be used as an element in a biological sewage/wastewater treatment apparatus to reduce nitrate in sludge.

The sludge provided in the nitrate-reducing reactor 110 includes the iron-oxidizing microorganism. More specifically, it serves to introduce the iron-oxidizing microorganism into raw water and predominantly culture the iron-oxidizing microorganism. The iron-oxidizing microorganism performs metabolic processes using iron as an electron donor under anaerobic conditions and is characterized by using divalent iron (Fe²⁺) as an electron donor required for metabolic processes. The Fe²⁺ released from the iron-oxidizing microorganism is converted to Fe³⁺ by microbial oxidation under anaerobic conditions while releasing an electron, and the released electron is used in the reduction of nitrate into nitrogen gas by the iron-oxidizing microorganism. The iron-oxidizing microorganism that is used in the present disclosure may be Thiobacillus dentrificans known to be present in activated sludge.

Specifically, the reduction of nitrate (NO₃—N) or nitrate (NO₃⁻) by the iron-oxidizing microorganism can be explained by a reaction formula as described below. The iron-oxidizing microorganism takes FeCO₃ and releases Fe²⁺ by metabolic processes, and the released Fe²⁺ is converted to Fe³⁺ by microbial oxidation under anaerobic conditions while releasing an electron, and the released electron is used in the reduction of nitrate into nitrogen gas by the iron-oxidizing microorganism.

10FeCO₃+2NO₃⁻+24H₂O->10Fe(OH)₃+N₂+10HCO₃⁻+8H⁺ Reaction Formula

As the iron-oxidizing microorganism takes FeCO₃, the nitrate-reducing reactor 110 should include FeCO₃. In the nitrate-reducing reactor 110, FeCO₃ is formed by a reaction between iron (Fe) and sodium carbonate (Na₂CO₃), which are supplied to the nitrate-reducing reactor 110. Sodium carbonate (Na₂CO₃) is supplied to impart alkalinity to sludge in the nitrate-reducing reactor 110, and iron (Fe) is supplied to provide an electron donor to the iron-oxidizing microorganism. For this, one side of the nitrate-reducing reactor 110 may be provided with a sodium carbonate supply unit 120 and an iron supply unit 130. The iron supply unit 130 may be provided in the nitrate-reducing reactor 110. In an embodiment, the iron supply unit 130 provided in the nitrate-reducing reactor 110 may have a mesh structure, and an iron compound such as a slag may be provided in the mesh structure so that iron can be supplied to the nitrate-reducing reactor 110 by oxidation of the slag. The slag from which iron had been completely released, that is, the slag which had been completely oxidized, may be removed from the mesh structure and replaced with a fresh slag.

Meanwhile, with respect to the above reaction formula, when iron is supplied in a state in which the iron-oxidizing microorganism is not present, only about 30% of the supplied iron participates in the oxidation reaction, and the released electron cannot be used in the microbial reduction of nitrate. On the contrary, when iron is supplied in a state in which the iron-oxidizing microorganism is present, the reaction shown in the above reaction formula is continuously performed by microbial oxidation, and thus the released electron is easily used in the reduction of nitrate by the iron-oxidizing microorganism.

As described above, the iron-oxidizing microorganism may be provided in the nitrate-reducing reactor 110 in a state in which it is loaded into a carrier. A process for loading the iron-oxidizing microorganism into the carrier can be performed in the following manner.

First, 10-20 v/v % of PVA (polyvinyl alcohol) and 1-5 v/v % of sodium alginate are mixed with each other in distilled water, and the mixed solution is sterilized by heating to 120° C. Then, the mixed solution is mixed with sludge at a volume ratio of 1:1 to prepare a sludge solution. As used herein, the term “sludge” refers to a sludge containing the iron-oxidizing microorganism predominantly cultured therein. Then, a mixture of H₃BO₃ and CaCl₂ is added dropwise to the sludge solution to gel the sludge solution, thereby forming beads. Herein, when beads are formed with stirring with a magnet stirrer, the beads can be prevented from agglomerating with each other. Then, unreacted sodium alginate is washed out with a KH₂PO₄ solution to yield a carrier having the iron-oxidizing microorganism loaded therein. The prepared beads refer to the carrier and contain the iron-oxidizing microorganism loaded therein.

If the iron-oxidizing microorganism is grown in the sludge suspension or attached to the surface of a general carrier, the iron-oxidizing microorganism can be lost due to the swelling of the sludge. However, when the iron-oxidizing microorganism is loaded into the beads as disclosed herein, the loss of the iron-oxidizing microorganism can be prevented.

The apparatus for reducing nitrate using the iron-oxidizing microorganism according to an embodiment of the present disclosure has been described above. Hereinafter, the operation of the apparatus for reducing nitrate will be described.

First, raw water containing the nitrate to be treated is supplied to the nitrate-reducing reactor. The raw water may be supplied from a biological sewage/wastewater treatment apparatus. In addition, the iron-oxidizing microorganism is previously provided to the nitrate-reducing reactor and may be provided in a state in which it is loaded into a carrier.

In this state, sodium carbonate (Na₂CO₃) is supplied to the nitrate-reducing reactor to maintain alkalinity, while iron (Fe) is supplied as an electron donor for the iron-oxidizing microorganism. Thus, in the nitrate-reducing reactor, sodium carbonate (Na₂CO₃) and iron (Fe) compounds react with each other to produce FeCO₃. Herein, the required alkaline material can be obtained from sewage or wastewater without injecting separate sodium carbonate.

Then, the iron-oxidizing microorganism takes the produced FeCO₃ and releases divalent (Fe²⁺) by metabolic processes. The released Fe²⁺ is converted to Fe³⁺ by microbial oxidation under anaerobic conditions while releasing an electron, and the released electron is used in the reduction of nitrate into nitrogen gas by the iron-oxidizing microorganism. This reaction is as shown in the above reaction formula.

The denitrified water in which nitrate was reduced by the above reaction is discharged to the outside. The denitrified water may be supplied to the aeration tank of a biological sewage/wastewater treatment apparatus or supplied to other reactors. In addition, after completion of the denitrification reaction, the carrier having the iron-oxidizing microorganism loaded therein may be recycled.

Hereinafter, the efficiency with which nitrate is removed by the apparatus for reducing nitrate using the iron-oxidizing microorganism according to an embodiment of the present disclosure will be described.

A 10-liter nitrate-reducing reactor made of a pyrex material was constructed, and 60% of the volume of the nitrate-reducing reactor was filed with a carrier having the iron-oxidizing microorganism loaded therein. The reactor, excluding an inlet port and an outlet port, was sealed, and then purged with nitrogen gas (N₂) and maintained in an anaerobic state. Then, 40 mg/L (as NO₃⁻) of nitrate solution (KNO₃) and 80 mg/L (as Fe²⁺) of divalent iron solution (FeSO₄), which contained no organic matter, were injected into the reactor by a peristaltic pump at a rate of 4 ml/min. In addition, 60 mg/L (as CO₃²⁻) of sodium carbonate (Na₂CO₃) was injected into the reactor to provide alkalinity. In this state, the reactor was operated for 5 days, and the results of the operation are shown in Tables 1 and 2 below.

TABLE 1
Concentration of NO₃⁻ over operating time

| Operating time | | | | | | |
|---|---|---|---|---|---|---|
| (day) | 1 | 2 | 3 | 4 | 5 | Average |
| NO₃⁻ (mg/L) | 47.53 | 49.15 | 35.51 | 38.55 | 38.74 | 41.90 |
| in influent | | | | | | |
| NO₃⁻ (mg/L) | 3.27 | 7.39 | 1.54 | 6.98 | 0.49 | 3.93 |
| in effluent | | | | | | |

TABLE 2
Consumption of divalent iron (Fe²⁺) over operating time

| Operating time | | | | | | |
|---|---|---|---|---|---|---|
| (day) | 1 | 2 | 3 | 4 | 5 | Average |
| Fe²⁻ (mg/L) | 76.7 | 92.7 | 106.5 | 64.2 | 73.3 | 82.68 |
| in influent | | | | | | |
| Fe²⁻ (mg/L) | 34.3 | 56.1 | 86 | 58.3 | 48.4 | 56.62 |
| in effluent | | | | | | |

As can be seen in Table 1 above, even though the solution introduced into the reactor contained no organic matter, 90% or more of the initial concentration of nitrate (NO₃) was removed. In addition, as can be seen in Table 2 above, the molar concentration of divalent iron consumed in the reaction with nitrate oxygen was 0.56 mM, which was not exactly consistent with the stoichiometry of the above-described reaction formula, but denitrification by the iron ions occurred. Further, ammonia that is a byproduct resulting from the reduction of nitrate was not substantially detected, suggesting that the removed nitrate was mostly reduced into nitrogen gas.

What is claimed is:

1. An apparatus for reducing nitrate using an iron-oxidizing microorganism, the apparatus comprising:
a nitrate-reducing reactor which is operated under anaerobic conditions and provides a space for reduction of nitrate; and
an iron-oxidizing microorganism provided in the nitrate-reducing reactor,
wherein the iron-oxidizing microorganism releases divalent iron (Fe²⁺), the released Fe²⁺ is converted to Fe³⁺ by microbial oxidation under anaerobic conditions while releasing an electron, and the released electron is used in reduction of nitrate into nitrogen gas by the iron-oxidizing microorganism.

2. The apparatus of claim 1, wherein sodium carbonate (Na₂CO₃) and ferrous ion (Fe²⁺) or iron (Fe) compounds are supplied to the nitrate-reducing reactor.

3. The apparatus of claim 2, wherein the iron-oxidizing microorganism takes an iron compound formed by a reaction between sodium carbonate (Na₂CO₃) and iron (Fe) compounds while releasing divalent iron (Fe²⁺) and reduces nitrate into nitrogen gas using an electron generated by microbial oxidation of Fe²⁺.

4. The apparatus of claim 1, wherein the nitrate-reducing reactor further includes an iron supply unit, and the iron supply unit serves to supply a ferrous iron (Fe²⁺) or an iron compounds.

5. The apparatus of claim 1, wherein the iron-oxidizing microorganism is provided in a state in which it is loaded into a carrier.

6. The apparatus of claim 5, wherein the carrier containing the iron-oxidizing microorganism loaded therein is prepared by a carrier preparation process comprising: preparing a mixed solution of PVA (polyvinyl alcohol), sodium alginate and distilled water, mixing a sludge containing the iron-oxidizing microorganism with the mixed solution at a volume ratio of 1:1 to prepare a sludge solution; and gelling the sludge solution.

7. The apparatus of claim 1, wherein the nitrate-reducing reactor serves to treat raw water discharged from a biological sewage/wastewater treatment apparatus or an artificial wetland, and the raw water contains nitrate.

8. A method for reducing nitrate using an iron-oxidizing microorganism, the method comprising: providing a carrier containing the iron-oxidizing microorganism in a nitrate-reducing reactor which is operated under anaerobic conditions; and supplying sodium carbonate (Na₂CO₃) and ferrous ion (Fe²⁺) or iron (Fe) compounds to the nitrate-reducing reactor containing the carrier; Wherein, the iron-oxidizing microorganism releases divalent iron (Fe²⁺), the released Fe²⁺ is converted to Fe³⁺ by microbial oxidation under anaerobic conditions while releasing an electron, and the released electron is used in reduction of nitrate into nitrogen gas by the iron-oxidizing microorganism.
